(19) United States
(12) Patent Application Publication
(10) Pub. No.: US 2013/0110611 A1
(43) Pub. Date: May 2, 2013

(54) SYSTEM AND METHOD FOR CONDUCTING SEMI-OPAQUE SALES TRANSACTIONS

(71) Applicant: Switchfly, Inc., San Francisco, CA (US)

(72) Inventor: Christopher Boyd, Oakland, CA (US)

(73) Assignee: Switchfly, Inc., San Francisco, CA (US)

(21) Appl. No.: 13/665,728

(22) Filed: Oct. 31, 2012

Related U.S. Application Data
(60) Provisional application No. 61/553,505, filed on Oct. 31, 2011.
(60) Provisional application No. 61/645,533, filed on May 10, 2012.

(51) Int. Cl. G06Q 30/02

(52) U.S. Cl. 705/14.27

(57) ABSTRACT

A method and system for conducting semi-opaque sales transactions associated with a loyalty program. In one preferred embodiment, the method may include the steps of receiving from the loyalty program, an identification of an inventory item eligible for discount; receiving from the loyalty program, a discounted cash price of the inventory item; determining a pricing factor corresponding to at least one of the inventory item, the discounted cash price, and a user; converting, in a manner hidden from the user, the discounted cash price of the inventory item into a number of loyalty program points having an equivalent value to the discounted cash price based on the pricing factor; and displaying the number of loyalty program points having an equivalent value to the discounted cash price while obscuring the discounted cash price. The system may include a controller, a rules engine, a processor, and a user interface.

### CROSS-REFERENCE TO RELATED APPLICATIONS

The present application claims priority to: Provisional Patent Application Ser. No. 61/553,505 entitled, “System and method for conducting semi-opaque sales transaction” and filed 31-OCT.-2011; and Provisional Patent Application Ser. No. 61/645,533 entitled, “System and method for conducting semi-opaque sales transaction” and filed 10-MAY-2012, which are both incorporated in their entirety by this reference.

### TECHNICAL FIELD

This invention relates generally to the sales field, and more specifically to a new and useful system and method for conducting semi-opaque sales transactions in the loyalty program rewards field.

### BACKGROUND

Travel suppliers, like most businesses, have a motivation to maximize revenue by offering lower priced inventory without adversely impacting their existing cash pricing structure. Current travel suppliers have a variety of pricing structures. For example, Priceline® has an opaque bid model (user bids on a star rating, which is shown a winning property once the bid is accepted). As another example, Hotwire® has an opaque brand model, in which the user is shown the cash price of an item upfront, but the name of the item is hidden and is revealed only until after the user completes the transaction. However, such opaque structures risk alienating customers who are uncomfortable with blind purchases. Some travel suppliers, such as Expedia®, Travelocity®, and Site59®, have a bundled pricing model (e.g., a package price of “hotel +air” is shown, but a separate price each for “hotel” and “air” is not shown). However, service providers may prefer to not distribute inventory to such bundling travel supplier sites, which undercut their existing full rate pricing, thereby disrupting their full rate sales. These various current pricing methods have disadvantages that limit the ability of travel suppliers to maximize revenue, including by disposing of distressed or excess inventory.

Thus, there is a need in the sales field to create a new and useful system and method for conducting semi-opaque sales transactions. This invention provides such a new and useful system and method.

### BRIEF DESCRIPTION OF THE FIGURES

FIG. 1 is a schematic of the system of a preferred embodiment;

FIG. 2 is a schematic of the pricing factors database;

FIGS. 3A and 3B are illustrative examples of a display provided by the system of a preferred embodiment; and

FIGS. 4-8 are flowcharts of the method of a preferred embodiment and variations thereof.

### DESCRIPTION OF THE PREFERRED EMBODIMENTS

The following description of preferred embodiments of the invention is not intended to limit the invention to these preferred embodiments, but rather to enable any person skilled in the art to make and use this invention.

### System for Conducting Semi-Opaque Sales Transactions

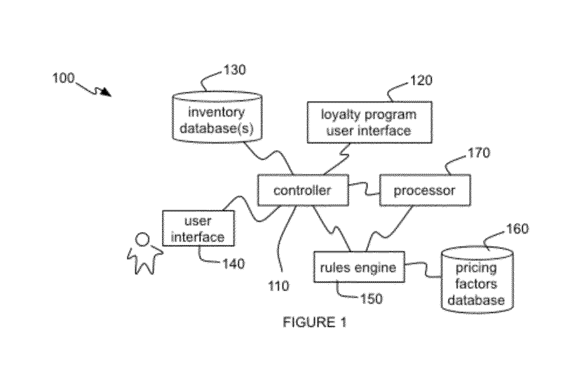

As shown in FIG. 1, in a preferred embodiment, the system 100 for conducting semi-opaque sales transactions associated with a loyalty program includes: a controller 110 configured to receive identification of an inventory item and a discounted cash price of the inventory item; a rules engine 150 configured to determine an applicable pricing factor corresponding to at least one of the inventory item, the discounted cash price, and a user; and a processor 170 configured to convert, in a manner hidden from the user, the discounted cash price of the inventory item into a number of loyalty program points having an equivalent value to the discounted cash price based on the pricing factor; and a user interface 140 coupled to the processor 170 and configured to display the number of loyalty program points having an equivalent value to the discounted cash price while obscuring the discounted cash price. In a preferred embodiment, the equivalent discounted points price of the inventory item is displayed while the discounted cash price of the inventory item is not displayed. In other words, the user is able to view a discounted points price and the name and/or description of the inventory item in a more comfortable, non-opaque manner, while the merchant is able to display a discounted price that does not undercut full rate cash sales through other sales channels. The system 100 may additionally or alternatively provide for display of a full (non-discounted) points price of the inventory item.

The system 100 preferably provides a way for merchants to sell discounted inventory items (e.g., excess items) and to potentially attract new customers and/or retain high-value loyal customers, without disrupting full rate cash sales. Furthermore, different discounts applied to a particular inventory item and/or different discounted inventory items can be made available to a particular customer segment, enabling different offers to be directed at a customer depending on the demographic or other attribute of the customer (e.g., member status with the loyalty program). The system 100 also preferably provides a convenient distressed inventory channel that enables merchants to sell last-minute distressed or excess inventory at a lower cost of distribution than other, more opaque pricing models. The system 100 is preferably implemented with travel service suppliers such as hotels or airlines, but can additionally or alternatively be implemented with any suitable merchants or service suppliers.

The controller no preferably functions to receive input regarding a discounted inventory item and/or a user potentially desiring to purchase a discounted inventory item. The controller no preferably receives identification of an inventory item that is eligible for discount and a discounted cash price of the inventory item. For instance, the controller no may receive, from a travel supplier, identification information regarding a hotel with vacant rooms that are to be sold at a discounted price. In one embodiment, the merchant or service provider supplying the inventory item preferably provides the information to the controller 110 through a loyalty program user interface 120. In another embodiment, the controller 110 retrieves the information from and/or stores the received information in an inventory database 130 or other storage device storing inventory information. For instance, the controller no can send one or more search queries to the inventory database. In one variation, the controller no receives a non-discounted price (e.g., “rack” price) of the inventory item in response to a first search query and receives a discounted price of the inventory item in response to a second query separate from the first query. In another variation, the controller no receives a non-discounted price and a discounted price of the inventory item in response to a single search query. In both of these variations, the amount of discount offered on the inventory item can be determined by calculating the difference between the non-discounted price and the discounted price. However, the identification, non-discounted cash price, and/or discounted cash price can be received in any suitable manner.

In one preferred embodiment, the controller no is configured to identify a user as associated with the loyalty program (e.g., identify the user as a loyalty program member). In one variation, the controller no is preferably configured to provide a user interface 140 for communicating with a user, such as for receiving loyalty program member login information. The controller 110 is preferably coupled to a user database or other storage device that maintains information about loyalty program members, such as demographics and status (e.g., “platinum” or “star level” status conferring different benefits of the loyalty program). In identifying a user, the controller no can compare member login information, entered in the user interface, to information stored in the user database, and authenticate the user as a member of a particular loyalty program. In some embodiments, the user interface can be an interface or website co-branded for the loyalty program and/or travel service provider or other merchant, similar to that described in U.S. Pat. No. 8,024,664 entitled “Co-brands for user interfaces in travel booking”, which is incorporated in its entirety herein by this reference.

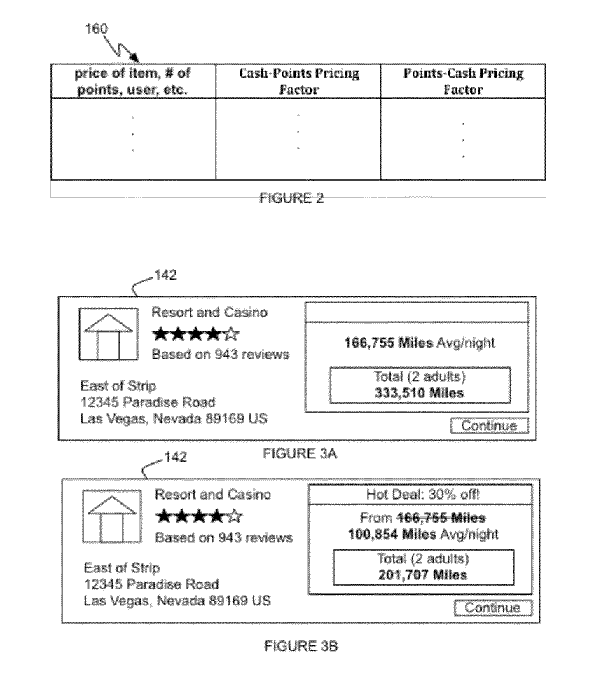

The rules engine 150 preferably functions to determine an applicable pricing factor corresponding to at least one of the inventory item, the discounted cash price, and a user. The rules engine 150 further functions to determine the applicable pricing factor on which the equivalent points value of the discounted cash price is based. In a preferred embodiment, the rules engine 150 is communicatively coupled to a pricing factors database 160 of pricing factors that convert between values of loyalty program points and cash currency. The pricing factors database 160 is preferably configured to store various tiers of cash-point pricing factors (cash-to-point and/or point-to-cash) pricing factors. For example, the pricing factors can be stored in a lookup table. As shown in FIG. 2, each tier can correspond to a particular cash price (non-discounted and/or discounted cash price) of the inventory item, such that the value of each loyalty program point (i.e. pricing factor) varies depending on the cash price of the inventory item. The pricing factor can additionally or alternatively vary with any suitable parameter, such as member demographic (e.g., dependent on loyalty program status or how long the user has been a member of the loyalty program, number of points in the account of the user, age, gender, user location), transaction history of the member (e.g., user historically seems more willing than an average user to pay more for luxury items) or product type or other attribute of the inventory item. Alternatively, the applicable pricing factor can be constant or based on an algorithm that calculates an applicable pricing factor. In a preferred embodiment, the rules engine 150 searches for, selects, or otherwise determines an applicable pricing factor from the pricing factors database 160. The applicable pricing factor is preferably communicated from the rules engine 150 to the controller 110 and/or processor 170.

In a preferred embodiment, each pricing factor preferably corresponds to a particular attribute of a particular customer or user (e.g. segment, demographic, individual), and/or a particular merchant (e.g., type, location, individual), inventory item, discounted cash price, and/or any suitable categorization. The pricing factors database 160 is preferably stored on a server or other storage device that is accessible by one or more computing devices. In some embodiments, the pricing factors database can be coupled to or otherwise accessible by the loyalty program, such as to enable a loyalty program to specify and/or adjust a particular pricing factor value. The pricing factors database may be stored on a server, computer, or other storage device associated with or otherwise connected to the loyalty program such that representatives from the loyalty program may populate and control the data stored within the database directly.

In a preferred embodiment, the rules engine 130 is implemented on a controller or a processor of a computing device, and can be configured to perform at least some of the processes described in the method below. In determining an equivalent value for the selected product, the processor 170 preferably communicates with the rules engine 130 to determine an appropriate pricing factor for at least one of the inventory item, the discounted cash price, and a user. In one embodiment, the rules engine 130 determines the pricing factor by table lookup. In alternative embodiments, the rules engine 130 determines the pricing factor by algorithm or in any suitable process. As described above, the pricing factors are associated with at least one of the inventory item, the discounted cash price, and a user. Additionally or alternatively, the pricing factors may be associated with at least one of the loyalty program, the target customer segment, the merchant, and any other suitable information. The rules engine 130 may select the pricing factor from the pricing factors database based on stored instructions, or may alternatively request and receive instructions (or the actual pricing factor) from the appropriate loyalty program. For example, different loyalty programs may offer different pricing factors to the same customer (or may offer different pricing factors to two different customers). For example, a first customer may have more loyalty program points with a first program, and may therefore receive a more favorable conversion factor from that program than from a second program. In some embodiments, the conversion factor may be selected based on the customer segment. For example, a premier or higher tier customer may receive a more favorable conversion factor and a lower level customer. In some embodiments, the conversion factor may be selected based on the merchant or inventory item. For example, loyalty programs may wish to encourage the use of points as a form a payment with a select few preferred merchants and/or inventory items, and may therefore offer a more favorable conversion factor for those merchants. In some embodiments, loyalty programs may wish to encourage the use of a larger number of points as a form a payment, and may therefore offer a more favorable conversion factor when the desired value for the payment device is higher. In some embodiments, the conversion factor may be selected based on any other suitable criteria or a combination of any suitable criteria.

The processor 170 preferably functions to convert in a manner hidden from the user, the discounted cash price of the inventory item into a number of loyalty program points having an equivalent value to the discounted cash price based on the pricing factor. The equivalent discounted price is preferably dependent on the applicable pricing factor. In particular, the processor 170 preferably converts the discounted cash price of the inventory item into an equivalent discounted points price by applying the pricing factor to the discounted cash price. For example, the processor 1ζcan apply a pricing factor of 100 (points per dollar) to a discounted inventory item of $150 to determine an equivalent discounted points price of 15,000 loyalty points ($150×100=15,000).

As shown in FIG. 1, the user interface 140 is preferably coupled to the processor 170 and functions to display the number of loyalty program points having an equivalent value to the discounted cash price while obscuring the discounted cash price. The user interface preferably functions to not display the discounted cash price, thereby reinforcing opacity of the transaction. As shown in FIGS. 3A and 3B, the system further includes display 142 that preferably functions to display the number of loyalty program points having an equivalent value to the discounted cash price while obscuring the discounted cash price. In some embodiments, the user interface can additionally display an initial non-discounted points price of the inventory item (which is preferably determined in a manner similar to determining the discounted points price, by applying a pricing factor to an initial non-discounted cash price of the inventory item). The display 142 can be different depending on the user, and/or display different discounts depending on the user. For example, as shown in FIG. 3A, a first points price of the inventory item is displayed to a first user on display 142. In FIG. 3B, a second discounted points price of the inventory item is displayed to a second user eligible for the second discounted points price, and the first points price (in “strikethrough” text or otherwise indicated as under deletion or correction) is also displayed to the second user on display 142 for comparison and to confer a sense of discount to the second user.

### Method for Conducting Semi-Opaque Sales Transactions

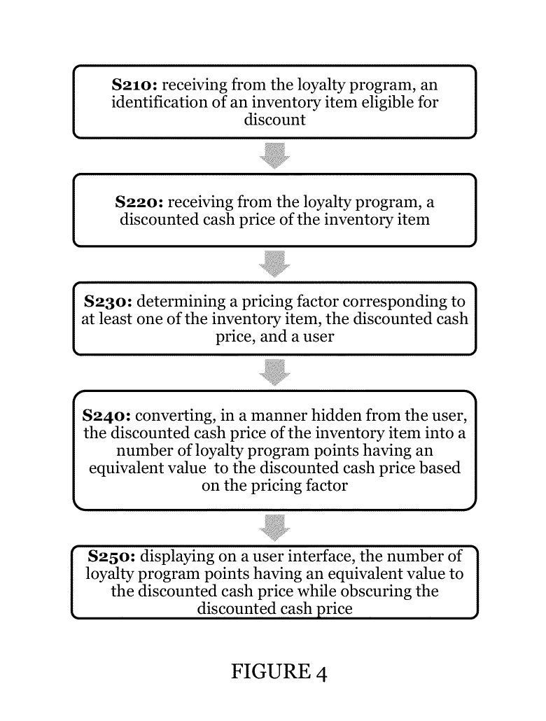

As shown in FIG. 4, in a preferred embodiment, the method for conducting semi-opaque sales transactions associated with a loyalty program includes: in block S210, receiving, from a first computer associated with the loyalty program, an identification of an inventory item eligible for discount; in block S220, receiving, from the first computer associated with the loyalty program, a discounted cash price of the inventory item; in block S230, determining a pricing factor corresponding to at least one of the inventory item, the discounted cash price, and a user; in block S240, converting, in a manner hidden from the user, the discounted cash price of the inventory item into a number of loyalty program points having an equivalent value to the discounted cash price based on the pricing factor; and in block S250, displaying on a user interface, the number of loyalty program points having an equivalent value to the discounted cash price while obscuring the discounted cash price. The equivalent discounted points price (e.g., in frequent flyer miles) is preferably based on the pricing factor and the discounted cash price of the inventory item. In a preferred embodiment, the method includes not displaying the discounted cash price of the inventory item. In other words, the user is preferably able to view a discounted points price and the name and/or description of the inventory item in a non-opaque manner, while the merchant is able to display a discounted price that does not undercut full rate cash sales through other sales channels. The method may additionally or alternatively include displaying a full (non-discounted) points price of the inventory item. The conversion between loyalty program points and cash values is preferably hidden from the user, thereby preventing the user from deriving the cash price of the inventory item from the points price and reinforcing opacity of the transaction.

The method preferably provides a way for merchants to sell discounted inventory items (e.g., excess items) and to potentially attract new customers without disrupting full rate cash sales. Furthermore, different discounts applied to a particular inventory item and/or different discounted inventory items can be made available to a particular customer segment, enabling different offers to be directed at a customer depending on the demographic or other attribute of the customer (e.g., member status with the loyalty program). The method is preferably implemented with travel service suppliers such as hotels or airlines, but can additionally or alternatively be implemented with any suitable merchants or service suppliers.

Block S210 receiving, from a first computer associated with the loyalty program, an identification of an inventory item eligible for discount. Block S220 recites receiving, from the first computer associated with the loyalty program, a discounted cash price of the inventory item. Blocks S210 and S220 preferably function to obtain information regarding a discounted inventory item. For example, a distressed or excess inventory item such as vacancies in an airline flight can be identified as suitable for a discount to entice customers and increase revenue. As another example, an inventory item such as rooms in a brand new hotel can be identified as suitable for a promotional discount and gain exposure to customers. The identification of the inventory item can be in the form of a code, name, or other suitable identification. In a preferred embodiment, the method includes receiving the identification of the discounted inventory item and/or discounted cash price through a user interface from a travel supplier or other suitable representative of the inventory item. In another embodiment, the method additionally or alternatively includes retrieving the identification of the discounted inventory item and/or discounted cash price by searching through an inventory database or other storage device with one or more search queries. In one variation, block S220 includes receiving a non-discounted price (e.g., “rack” price) of the inventory item in response to a first search query and receiving a discounted price of the inventory item in response to a second query separate from the first query. In another variation, block S220 includes receiving a non-discounted price and a discounted price of the inventory item in response to a single search query. In both of these variations, the amount of discount offered on the inventory item can be determined by calculating the difference between the non-discounted price and the discounted price. However, the identification, non-discounted cash price, and/or discounted cash price can be received in any suitable manner. In some embodiments, the method may further include receiving, from the loyalty program, pricing factor information. As described herein, the pricing factor may be specific to the inventory item or the discounted cash price of the inventory item. In some embodiments, the loyalty program may specify a plurality of pricing factors, that correspond to different users (for example their tier, segment, and/or status), different merchants, different inventory items, different cash values (of the discounted or regular price, for example), or any other suitable category. The method may receive specific pricing factors and/or pricing factor instructions.

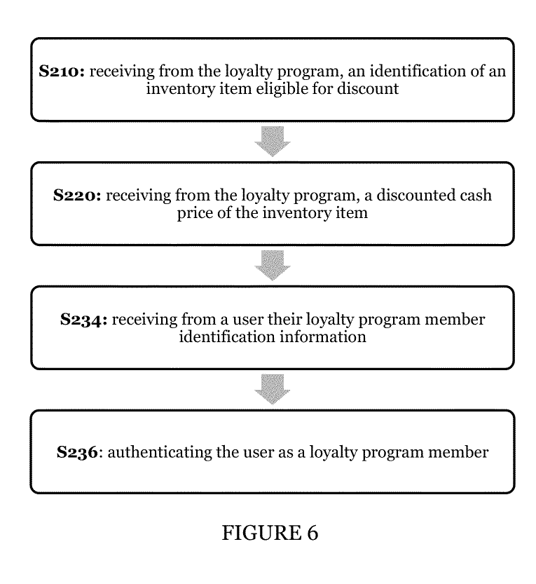

In some embodiments, as shown in FIG. 6, the method may further include the steps of receiving from a user their loyalty program member identification information in block S234 and authenticating the user as a loyalty program member in block S236. In some embodiments, the member identification information may include loyalty program login information, the user's name; and/or the user's loyalty program member identification information such as username, password, and member ID. In some embodiments, upon authenticating the user with the loyalty program, the method may further include the step of receiving profile information. Alternatively, in some embodiments, the member profile information may be stored, and updated, with the system described herein. A user's or member's profile information may include name, their current pricing factor or factors, current loyalty program points balance, number of points the user has available for purchases, the cash value of their total balance of loyalty program points, the cash value of the number of points the user has available for purchases, (alternatively, these numbers may be calculated from the pricing factor), current loyalty program customer segment (e.g. “gold”, “platinum”, “premium”, etc.), years as a member of the loyalty program, and any other suitable information. Additionally, the user information package may also include information about the loyalty program contract in general and/or specific to the user. In some embodiments, this user information may be utilized in the determining a pricing factor step as described in more detail below.

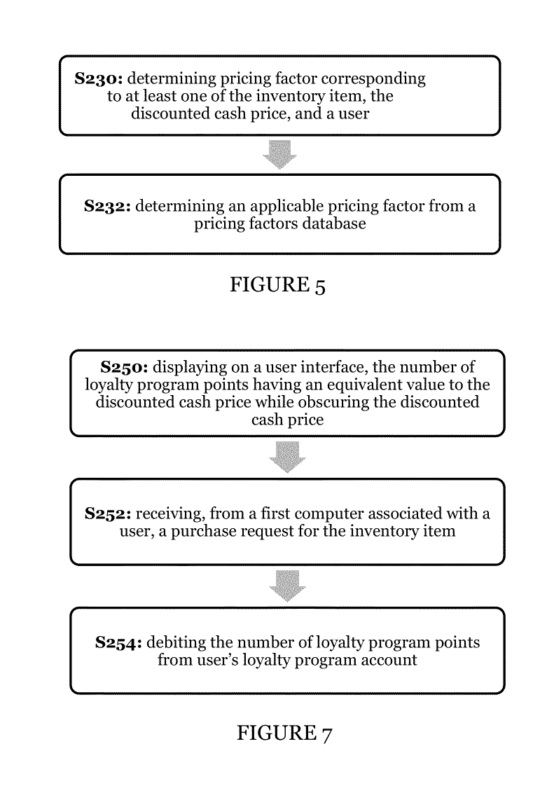

Block S230 recites determining a pricing factor corresponding to at least one of the inventory item, the discounted cash price, and a user. Block S230 preferably functions to determine a conversion factor that converts the discounted cash price of the inventory item to a discounted points price in loyalty program points. The pricing factors preferably convert between values of cash currency and loyalty program points. As shown in FIG. 5, in a preferred embodiment, the method includes block S232, which recites determining an applicable pricing factor from a pricing factors database 160, such as through a search query or table lookup. The pricing factors database 160 is preferably configured to store various tiers of cash-point pricing factors (cash-to-point and/or point-to-cash), and the tiers can be organized based on one or more parameters. The applicable pricing factor can be based on parameters such as the cash price (non-discounted and/or discounted cash price) of the inventory item, such that the value of each loyalty program point varies depending on the cash price of the inventory item. The pricing factor can additionally or alternatively vary with any suitable parameter, such as member demographic (e.g., dependent on loyalty program status or how long the user has been a member of the loyalty program, age, gender, user location), transaction history of the member (e.g., user historically seems more willing than an average user to pay more for luxury items) or product type or other attribute of the inventory item. In some embodiments, the conversion factor may depend on the user's customer segment. For example if the user is a premium customer (for example, they have a large balance of points, they recently purchased an expensive ticket, they have been a member for several years, they have a credit card associated with the loyalty program, etc.) they may receive a more favorable conversion factor than a user in a lower customer segment. A more favorable conversion factor may be one that provides a higher cash value for the same number of points. In some embodiments, if the pricing factor selection is dependent on user specific information, the discounted cash price may be converted to two different numbers of loyalty points for two different users. For example, for a first user, the discounted cash price is converted to a first number of loyalty points based on a first pricing factor. The same discounted cash price may be converted to a second, different number of loyalty points based on a second pricing factor applicable to the second user. Alternatively, the applicable pricing factor can be constant or based on an algorithm that calculates an applicable pricing factor.

Block S240 recites converting, in a manner hidden from the user, the discounted cash price of the inventory item into a number of loyalty program points having an equivalent value to the discounted cash price based on the pricing factor. Block S240 functions to determine an opaque valuation of the inventory item in terms of the loyalty program points. For example, based on a pricing factor of 100 (points per dollar), block S240 determines that an inventory item with a discounted cash price of $150 has an equivalent discounted points price of 15,000 points ($150×100=15,000). The specific mathematical operation (such as multiplication or division) to convert the cash price to the points price can vary depending on the nature of the pricing factor. Alternatively, the conversion can include any suitable mathematical operation or algorithm.

Block S250 recites displaying on a user interface, the number of loyalty program points having an equivalent value to the discounted cash price while obscuring the discounted cash price. In a preferred embodiment, the method includes not displaying the discounted cash price. In another variation, the method further includes not displaying the initial cash price. Block S250 functions to present, to the user for potential purchase, the inventory item at a discount in a semi-opaque manner that obscures the discounted cash price, such that the discounted inventory item is not easily comparable to other cash prices for the inventory items while allowing the user to see the details (e.g., name, description) of the inventory item.

In some embodiments, the step of displaying the number of loyalty program points may further include displaying any suitable loyalty program profile information. The user's loyalty program profile information may include, as described above, current loyalty program points balance, number of points the user has available for purchases, the cash value of their total balance of loyalty program points, the cash value of the number of points the user has available for purchases, current loyalty program customer segment (e.g. “gold”, “platinum”, “premium”, etc.), years as a member of the loyalty program, and any other suitable information.

In some embodiments, as shown in FIG. 7, the method may further include the step of receiving, from a first computer associated with a user, a purchase request for the inventory item in block S252. This step functions to facilitate the sale of the inventory item to the user. The user may confirm that they wish to purchase the inventory item using the number of loyalty points displayed. In some embodiments, if the user's number of points the user has available for purchases is not high enough to purchase the inventory item at the displayed points price. In this embodiment, the method may perform the additional step of performing additional checks to determine if the user qualifies to purchase the stored value payment device with a combination of loyalty program points and cash. For example a user may only have an available balance of 500 loyalty points. The inventory item may cost 5,000 points. If the user is qualified to use a combination of points and cash, they may be able to utilize their balance of 500 points in addition to spending $₄₅ (based on a 100 points/$ pricing factor) to meet the balance. If the user qualifies for this feature, the method may return the number of points that the member will need to redeem as well as the cash equivalent amount to meet the balance.

In some embodiments, as shown in FIG. 7, the method may further include the step of debiting the number of loyalty program points from user's loyalty program account in block S254. This step preferably functions to “transfer” the loyalty program points from the loyalty program account of the user in exchange for the discounted inventory item. Debiting the number value of loyalty program points from the loyalty program account of the user is preferably performed in real-time, although transferring points from the loyalty program account of the user can be performed in any suitable manner.

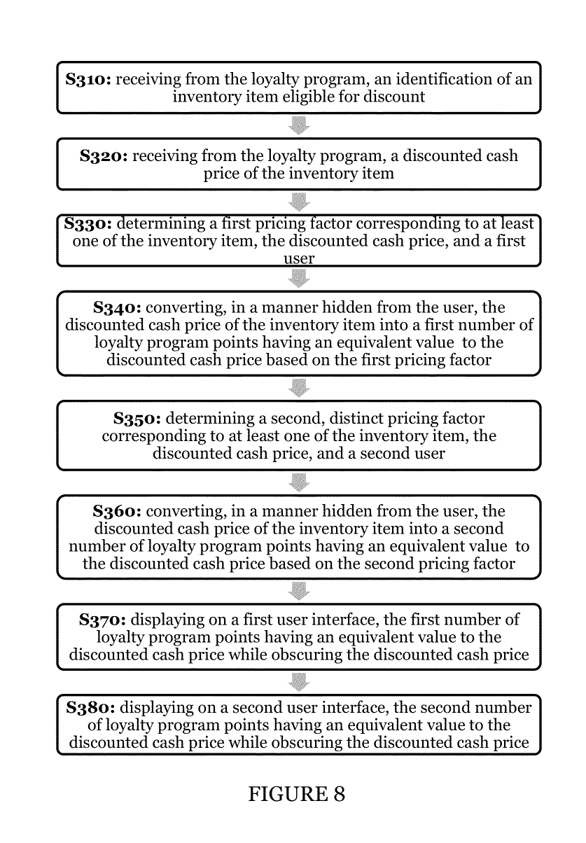

As shown in FIG. 8, in one preferred embodiment of the method, the method 300 includes: in block S310, receiving, from a first computer associated with the loyalty program, an identification of an inventory item eligible for discount; in block S320, receiving, from the first computer associated with the loyalty program, a discounted cash price of the inventory item; in block S330, determining a first pricing factor corresponding to at least one of the inventory item, the discounted cash price, and a first user; in block S340, converting, in a manner hidden from the user, the discounted cash price of the inventory item into a first number of loyalty program points having an equivalent value to the discounted cash price based on the first pricing factor; in block S350, determining a second, distinct pricing factor corresponding to at least one of the inventory item, the discounted cash price, and a second user; in block S360, converting, in a manner hidden from the user, the discounted cash price of the inventory item into a second number of loyalty program points having an equivalent value to the discounted cash price based on the second pricing factor; in block S370, displaying on a first user interface, the first number of loyalty program points having an equivalent value to the discounted cash price while obscuring the discounted cash price; and in block S380 displaying on a second user interface, the second number of loyalty program points having an equivalent value to the discounted cash price while obscuring the discounted cash price. Blocks S330 and S350 are preferably performed in a similar manner as block S230 described above. Blocks S340 and S360 are preferably performed in a similar manner as block S240 described above. Blocks S370 and S380 are preferably similar to block S250 described above. This embodiment of the method, the method preferably enables different discounts (including no discount) to be made available in a semi-opaque manner to different users. For example, the first pricing factor may result in a lower discounted points price of the inventory item that is available to a highest level “platinum” loyalty program member, while the second points pricing factor may result in a higher points price of the inventory item that is available to a second highest level “gold” loyalty program member.

The system and method of the preferred embodiment can be embodied and/or implemented at least in part as a machine configured to receive a computer readable medium storing computer-readable instructions. The instructions are preferably executed by computer-executable components preferably integrated with the system. The computer-readable medium can be stored on any suitable computer readable media such as RAMs, ROMs, flash memory, EEPROMs, optical devices (CD or DVD), hard drives, floppy drives, or any suitable device. The computer-executable component is preferably a general or application specific processor but any suitable dedicated hardware device or hardware/firmware combination device can (alternatively or additionally) execute the instructions. Although omitted for clarity, the preferred embodiments of the method include every combination and permutation of the processes described herein. It should be understood that any of the foregoing processes can be performed by any suitable device, in any suitable order, in a serial or parallel manner.

### Example Implementation of the System and Method

The following example implementation of the preferred system and method is for illustrative purposes only, and should not be construed as definitive or limiting of the scope of the claimed invention. In one illustrative example, a selected hotel room, normally $150 per night, is discounted to $100 per night. The discounted hotel room rate is available only to members of Loyalty Program X. A user (a member of Loyalty Program X) logs into a website co-branded for Loyally Program X, using his member login information. The system authenticates the user as a member of Loyalty Program X and retrieves his profile and account information, such as number of loyalty program points available. The user enters a search query for various travel services, which returns the discounted hotel room that is available only to members of Loyalty Program X like the user.

According to a determined pricing factor of 100 (points per dollar), the hotel room at full rate has an equivalent points price of 15,000 points (150×100=15,000), and the hotel room at the discounted rate has an equivalent discounted points price of 10,000 points (100×100=10,000). The discounted hotel room name, description, full points price of 15,000 points, and discounted points price of 10,000 are displayed to the user. The discounted cash price and the full cash price are not shown. Since the point conversion algorithm is unknown to the user, the user cannot derive the discounted cash price, or the full cash price, of the hotel room. However, a sense of the discounted value is conferred to the user by the juxtaposed full points price and discounted points price.

The user selects purchase of the discounted hotel room using his 10,000 of his loyalty program points. During the transaction, the system debits the appropriate number of loyalty program points from the loyalty program account of the user.

As a person skilled in the art will recognize from the previous detailed description and from the figures and claims, modifications and changes can be made to the preferred embodiments of the invention without departing from the scope of this invention defined in the following claims.

We claim:

1. A method for conducting semi-opaque sales transactions associated with a loyalty program, the method comprising the steps of:
receiving, from a first computer associated with the loyalty program, an identification of an inventory item eligible for discount;
receiving, from the first computer associated with the loyalty program, a discounted cash price of the inventory item;
determining a pricing factor corresponding to at least one of the inventory item, the discounted cash price, and a user;
converting, in a manner hidden from the user, the discounted cash price of the inventory item into a number of loyalty program points having an equivalent value to the discounted cash price based on the pricing factor; and
displaying on a user interface, the number of loyalty program points having an equivalent value to the discounted cash price while obscuring the discounted cash price.

2. The method of claim 1, wherein the determining step further comprises determining a pricing factor corresponding to at least one of user demographic and user customer segment.

3. The method of claim 1, wherein the receiving steps comprise receiving information through a user interface from a loyalty program.

4. The method of claim 1, wherein the receiving steps comprise receiving information by searching an inventory database with one or more search queries.

5. The method of claim 1, wherein the determining step comprises selecting a pricing factor corresponding to at least one of the loyalty program and the merchant.

6. The method of claim 1, wherein the displaying step comprises displaying the inventory item price in a semi-opaque manner that obscures the discounted cash price such that the discounted inventory price is not easily comparable to other cash prices for inventory items.

7. A method for conducting semi-opaque sales transactions associated with a loyalty program, the method comprising the steps of:
receiving, from a first computer associated with the loyalty program, an identification of an inventory item eligible for discount;
receiving, from the first computer associated with the loyalty program, a discounted cash price of the inventory item;
determining a first pricing factor corresponding to at least one of the inventory item, the discounted cash price, and a first user;
converting, in a manner hidden from the user, the discounted cash price of the inventory item into a first number of loyalty program points having an equivalent value to the discounted cash price based on the first pricing factor;
determining a second, distinct pricing factor corresponding to at least one of the inventory item, the discounted cash price, and a second user;
converting, in a manner hidden from the user, the discounted cash price of the inventory item into a second number of loyalty program points having an equivalent value to the discounted cash price based on the second pricing factor;
displaying on a first user interface, the first number of loyalty program points having an equivalent value to the discounted cash price while obscuring the discounted cash price; and
displaying on a second user interface, the second number of loyalty program points having an equivalent value to the discounted cash price while obscuring the discounted cash price.

8. A system for conducting semi-opaque sales transactions associated with a loyalty program, the system comprising
a controller configured to receive identification of an inventory item and a discounted cash price of the inventory item;
a rules engine configured to determine an applicable pricing factor corresponding to at least one of the inventory item, the discounted cash price, and a user;
a processor configured to convert, in a manner hidden from the user, the discounted cash price of the inventory item into a number of loyalty program points having an equivalent value to the discounted cash price based on the pricing factor; and
a user interface coupled to the processor and configured to display the number of loyalty program points having an equivalent value to the discounted cash price while obscuring the discounted cash price.

9. The system of claim 8, wherein the user interface is configured to display a full non-discounted points price for the inventory item.

10. The system of claim 8, wherein the user interface is configured to receive loyalty program user login information.

11. The system of claim 8, wherein the controller is coupled to a user database that maintains information about loyalty program members, such as demographics and status.

12. The system of claim 8, wherein the controller is configured to authenticate a user as a member of a particular loyalty program.

13. The system of claim 8, wherein the controller is configured to compare member login information entered in the user interface to information stored in the user database.

14. The system of claim 8, wherein the user interface is a website associated with the loyalty program.

15. The system of claim 8, wherein the controller is configured to receive identification of an inventory item from a user desiring to purchase the inventory item.

16. The system of claim 8, wherein the controller is configured to retrieve information from an inventory database.

17. The system of claim 8, wherein the controller is further configured to send one or more search queries to the inventory database.

18. The system of claim 8, wherein the rules engine is coupled to a pricing factors database that stores a plurality of pricing factors.

19. The system of claim 8, wherein the rules engine searches for, selects, or otherwise determines an applicable pricing factor from the pricing factors database.
